(19) United States
(12) Patent Application Publication
(10) Pub. No.: US 2012/0120514 A1
(43) Pub. Date: May 17, 2012

(54) STRUCTURE COMPRISING AT LEAST ONE REFLECTING THIN-FILM ON A SURFACE OF A MACROSCOPIC OBJECT, METHOD FOR FABRICATING A STRUCTURE, AND USES FOR THE SAME

(75) Inventor: Jarmo Maula, Espoo (FI)

(73) Assignee: Beneq Oy, Vantaa (FI)

(21) Appl. No.: 13/258,181

(22) PCT Filed: Apr. 7, 2010
(86) PCT No.: PCT/FI10/50269

§ 371 Date: Feb. 1, 2012

(30) Foreign Application Priority Data
Apr. 8, 2009 (FI) 20095382

(51) Int. Cl. G02B 5/08; B05D 5/06

(52) U.S. Cl. 359/838; 427/162

(57) ABSTRACT

A structure comprising at least one reflecting thin-film on a surface of a macroscopic object is disclosed. The surface of the macroscopic object, without the at least one thin-film, reflects less than 50% of incident light in the visible wavelength band and is opaque, and reflection of visible light from the surface of the macroscopic object, with the at least one thin-film on the surface of the macroscopic object, is essentially spectrally uniform and flat over available viewing angles. The at least one thin-film is dielectric and essentially transparent to visible light, and the at least one thin-film is fabricated by exposing the surface of the macroscopic object to alternately repeating, essentially self-limiting, surface reactions of two or more precursors, for increasing the reflectance of specularly reflected visible light in the visible wavelength band from the surface.

### FIELD OF THE INVENTION

The present invention relates to thin-film technology. Especially the present invention relates to structures comprising thin-films for adjusting the optical properties of a surface.

### BACKGROUND OF THE INVENTION

Many consumer appliances include functions which take advantage of electromagnetic waves in radio frequencies (RF). Examples of these appliances include cellular phones, personal computers, PDAs, cordless speakers, etc. Electrically conductive parts or surfaces in the propagation path of the RF-waves can distort, or prevent outright, the correct operation of these appliances.

It may nevertheless be desired that the optical properties of the surfaces of these appliances, or any other objects, be tailored using coatings which have a sufficiently high reflectance of specularly reflected visible light and a sufficiently uniform and flat reflectance spectrum (i.e. sufficiently wavelength independent reflectance) in the visible wavelength range. It may also be beneficial to be able to reduce the diffuse reflection of visible light relative to the specular reflection of visible light from e.g. the exposed surface of the appliances.

In the prior art the aforementioned optical properties have been obtained using metal coatings. For example aluminum surfaces possess the aforementioned useful combination of optical properties. A problem with metal surfaces, however, is that they are electrically conductive. Therefore the areas, in which metal coatings can be used in e.g. the aforementioned appliances, may be restricted to areas where the coatings do not distort the propagation of RF-waves or do not cause functional limitations to the RF-means of an appliance. Furthermore, due to their electrical conductivity, metal coatings may not be suitable or desired in devices or objects whose purpose is to provide electrical insulation.

The surface of many appliances, e.g. appliances which take advantage of electromagnetic waves in radio frequencies (RF), may be large or complex in shape. A problem with prior-art methods for depositing reflecting films, such as chemical vapour deposition (CVD) or physical vapour deposition (PVD), is that these methods are not able to deposit sufficiently uniform thin-films over these or other three dimensional objects or over large surface areas. Difficulties in achieving sufficient homogeneity with these deposition methods may arise especially in applications where the deposited films must be optically homogeneous and have a uniform thickness over the large or complex three dimensional surface.

### PURPOSE OF THE INVENTION

A purpose of the present invention is to reduce the aforementioned technical problems of the prior art by providing new types of structures comprising dielectric and reflecting films, and new fabrication methods for structures comprising dielectric and reflecting films on objects of various shapes, to increase the reflectance of specularly reflected visible light in the visible wavelength band from the surface of the objects.

### SUMMARY OF THE INVENTION

The structure, the method and the uses according to the present invention are characterized by what is presented in the claims.

A structure according to the present invention is characterized by what is presented in independent claim 1.

A method according to the present invention is characterized by what is presented in independent claim 11. A use according to the present invention is characterized by what is presented in claim 21 or in claim 22.

A structure according to the present invention comprises at least one reflecting thin-film residing on a surface of a macroscopic object. The surface of the macroscopic object, without the at least one thin-film, reflects less than 50% of incident light in the visible wavelength band and is opaque. Further, reflection of visible light from the surface of the macroscopic object, with the at least one thin-film on the surface of the macroscopic object, is essentially spectrally uniform and flat over available viewing angles. The at least one thin-film is dielectric and essentially transparent to visible light (wavelength of around 380 nm to 750 nm depending on the definition), and the at least one thin-film is fabricated by exposing the surface of the macroscopic object to alternately repeating, essentially self-limiting, surface reactions of two or more precursors, for increasing the reflectance of specularly reflected visible light in the visible wavelength band from the surface.

A method, according to the present invention, for fabricating a structure comprising at least one reflecting thin-film on a surface of a macroscopic object, comprises the step of depositing at least one thin-film on the surface by exposing the surface to alternately repeating, essentially self-limiting, surface reactions of two or more precursors, the surface of the macroscopic object, without the at least one thin-film, reflecting less than 50% of incident light in the visible wavelength band and being opaque, and reflection of visible light from the surface of the macroscopic object, with the at least one thin-film on the surface of the macroscopic object, being essentially spectrally uniform and flat over available viewing angles and the at least one thin-film being dielectric and essentially transparent to visible light for increasing the reflectance of specularly reflected visible light in the visible wavelength band from the surface.

According to the present invention, the structure is used as a means to increase the reflectance of specularly reflected visible light in the visible wavelength band from the surface of a macroscopic object.

According to the present invention, the method for fabricating a structure is used as a method to increase the reflectance of specularly reflected visible light in the visible wavelength band from the surface of a macroscopic object.

In this context “a macroscopic object” should be understood as an object whose appearance and optical properties (e.g. color or reflectance) can be evaluated with the naked eye.

In this context “a surface” should be understood as a surface of a macroscopic object which is visible to the naked eye.

In one embodiment of the present invention the surface of the macroscopic object is three dimensional (3D).

In one embodiment of the present invention the object is a non-flat object. In this context “thin-film” should be understood as a film having a thickness in the range of a fraction of a nanometer (nm) to several micrometers.

The refractive index is a function of wave-length. In this context a value indicated for a refractive index is the value of the refractive index at the visible wavelength of 550 nm.

The reflectance of specularly reflected visible light in the visible wavelength band from the surface of a macroscopic object can be increased cost-effectively by depositing, on this surface, at least one dielectric thin-film having good transparency to visible light. A benefit associated with the increase in the reflectance of specularly reflected visible light in the visible wavelength band, is that the appearance of the macroscopic object can be effectively made “metallic” with dielectric, visibly transparent, thin-films. Therefore the present invention can provide “metallic”-looking surfaces on macroscopic objects without the need to use electrically conductive, actually metal coatings. An additional benefit associated with this increase in the reflectance of specularly reflected visible light in the visible wave-length band from the surface, is that heating of the object by radiation energy in the visible wavelength band may potentially be reduced as a result of a possible decrease in scattering processes in the object.

Deposition processes based on alternately repeating, essentially self-limiting, surface reactions of two or more different precursors, one precursor at a time, can be used to deposit the dielectric thin-films highly uniformly, with high optical homogeneity and minimal surface roughness. Such processes include e.g. atomic layer deposition (ALD). This alternate use of precursors in order to expose the surface to alternately repeating surface reactions of two or more precursors is characteristic to the deposition process often called atomic layer deposition (ALD). Other names besides ALD have also been employed for these types of processes, where the alternate introduction of two or more different precursors lead to the growth of the deposit, often through essentially self-limiting surface reactions. These other names or process variants include atomic layer epitaxy (ALE), atomic layer chemical vapour deposition (ALCVD), and corresponding plasma enhanced variants. In the following, unless otherwise stated, these processes will be collectively addressed as ALD-type processes in this specification. When the surface of the object is three dimensional and complex in shape, these processes can be used to deposit the thin-films on the surface such that the optical properties of the surface remain similar even over large areas.

In one embodiment of the invention the macroscopic object is arranged to perform RF-functions or electrical insulation functions. As the thin-films are dielectric, they can be relatively freely deposited on any part of a surface of an RF-appliance, or any other object performing RF-functions, without markedly affecting the RF-functions of the object. Also objects performing insulating functions may require that dielectric materials be employed in specific places of the objects. An example of such an object is e.g. an object which is used in a wet or a humid environment and/or where the object resides close to a dangerous voltage source. These kinds of objects may be found from e.g. bathroom or kitchen furniture where a structure according to some embodiments of the invention, giving a “metallic”-looking appearance, may additionally be desired.

The surface of the macroscopic object, without the at least one thin-film, is opaque. The trans-mission of the surface is essentially zero. When the surface of the macroscopic object, without the at least one thin-film, is opaque, the “metallic”—appearance of the surface of the macroscopic object is strongly emphasized as a result of the at least one thin-film being formed on the surface.

In one embodiment of the present invention the surface of the macroscopic object, without the at least one thin-film, reflects less than 40% of incident light in the visible wavelength band. In one embodiment of the present invention the surface of the macroscopic object, without the at least one thin-film, reflects less than 20% of incident light in the visible wavelength band. In one embodiment of the present invention the surface of the macroscopic object, without the at least one thin-film, reflects less than 10% of incident light in the visible wavelength band. When the percent of reflection of incident light in the visible wavelength band decreases, the surface of the macroscopic object, without the at least one thin-film, is darker and thus results in an emphasized metallic appearance as a result of the at least one thin-film formed on the surface.

In one embodiment of the present invention the diffuse reflection of visible light from the surface of the macroscopic object, without the at least one thin-film, is essentially spectrally uniform and flat.

In one embodiment of the present invention the surface of the macroscopic object, without the at least one thin-film, is essentially black. In one embodiment of the present invention the surface of the macroscopic object is selected from the group consisting of polymer and glass. In one embodiment of the present invention the surface of the macroscopic object is plastic.

In one embodiment of the present invention the visual appearance of the structure is essentially independent of the viewing angle.

In one embodiment of the present invention, the structure comprises only one thin-film, the refractive index of the thin-film being above 1.5 (the refractive index of vacuum is 1), preferably above 1.8 and most preferably above 2.1, in the visible wave-length range. A very reliable and cost-effective structure and method for increasing the reflectance of specularly reflected visible light in the visible wavelength band from the surface, is to fabricate on the surface of the object a single dielectric thin-film having a high refractive index and being trans-parent for visible light. This kind of structure does not require much material and is less susceptible to cracking by stresses in the structure caused by e.g. thermal expansion or lattice mismatch of the thin-film material to the substrate (i.e. to the surface of the object).

In another embodiment of the present invention, the thickness of one thin-film is in the range of 20 nm to 100 nm.

It was surprisingly found that, by depositing on the surface of the object a single dielectric visibly transparent thin-film with a thickness in the range of 20 nm to 100 nm, the angle dependent reflectance was significantly reduced and an essentially homogenous “metallic”-color effect, essentially independent of the viewing angle, was obtained.

In yet another embodiment of the present invention, the material of the thin-film is selected from the group consisting of titanium oxide and aluminum oxide. Titanium oxide has a high refractive index, which dictates into a high reflectance from an interface between the surface of a titanium oxide thin-film and air. Therefore titanium oxide is a very well suited material to be fabricated on the surface of the object as a thin-film.

In one embodiment of the present invention, the at least one dielectric thin-film is fabricated by an atomic layer deposition type process.

In one embodiment of the method of the present invention, the step of depositing at least one dielectric thin-film comprises, depositing the at least one thin-film by atomic layer deposition.

The embodiments of the invention described hereinbefore may be used in any combination with each other. Several of the embodiments may be combined together to form a further embodiment of the invention. A product, a method or a use, to which the invention is related, may comprise at least one of the embodiments of the invention described hereinbefore.

### DETAILED DESCRIPTION OF THE INVENTION

In the following, the present invention will be described in more detail with exemplary embodiments by referring to the accompanying figures, in which

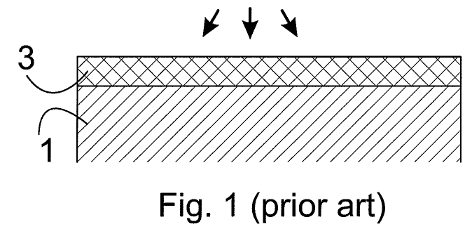

FIG. 1 is a schematic illustration of a reflecting coating of the prior art on a surface of an object,

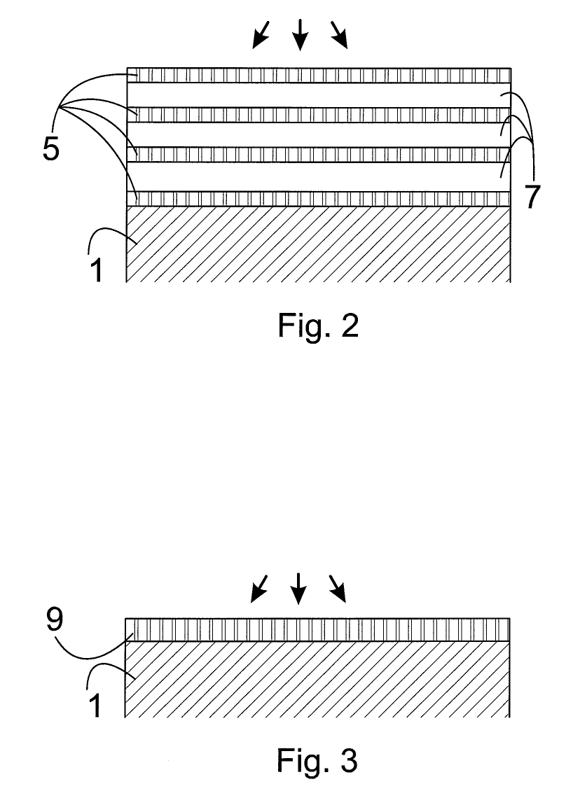

FIG. 2 is a schematic illustration of a structure according to one embodiment of the present invention,

FIG. 3 is a schematic illustration of a structure according to another embodiment of the present invention,

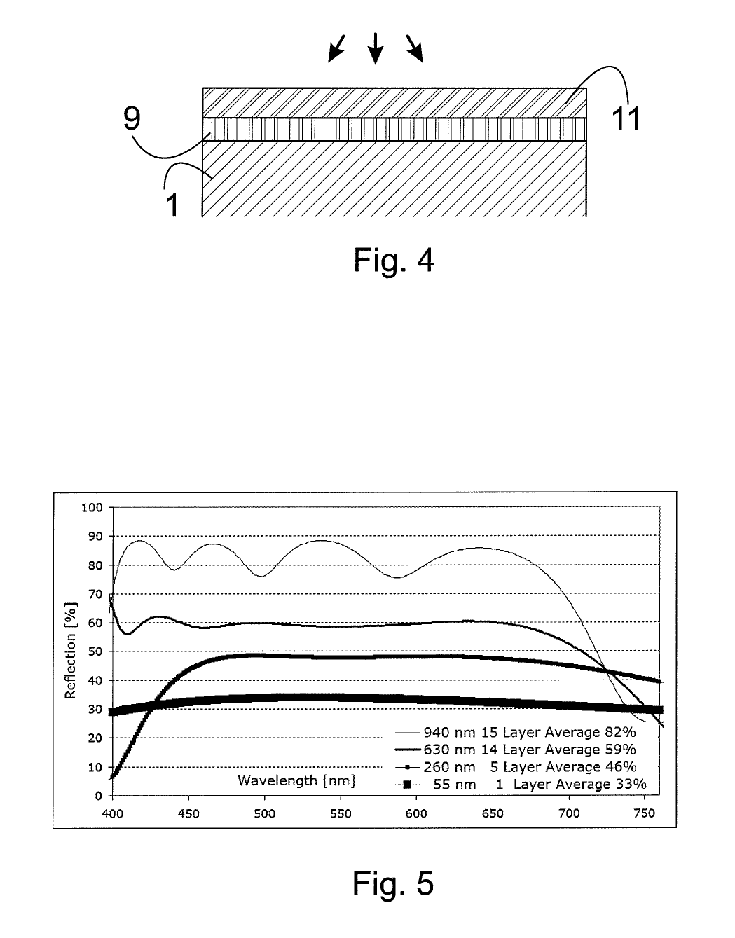

FIG. 4 is a schematic illustration of a structure according to another embodiment of the present invention,

FIG. 5 presents reflectance spectra from structures according to some embodiments of the present invention,

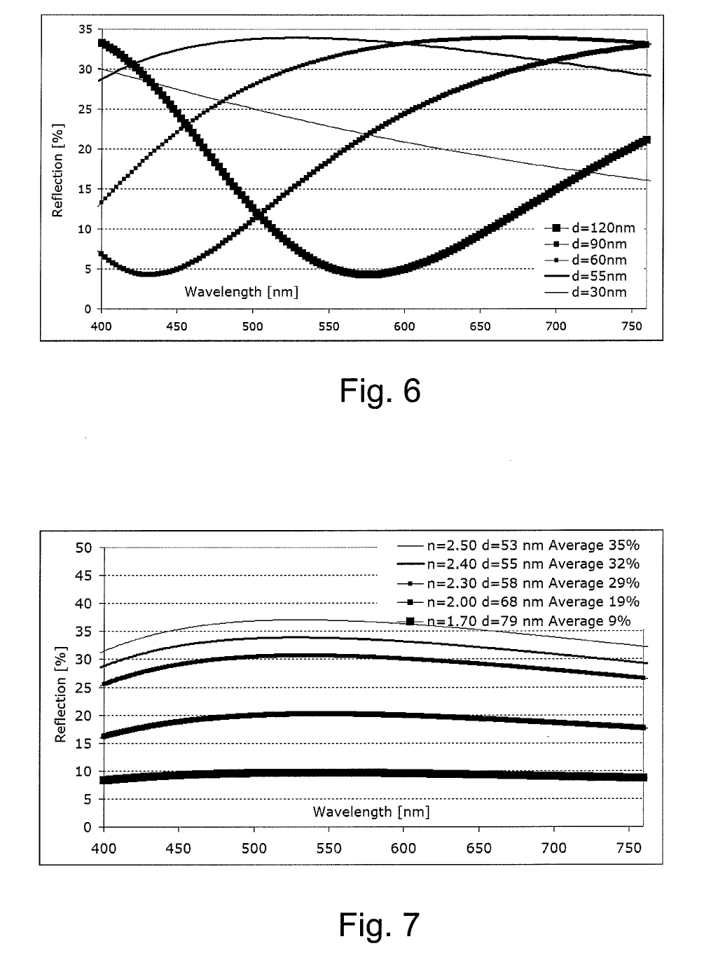

FIG. 6 presents reflectance spectra from structures according to some embodiments of the present invention, and

FIG. 7 presents reflectance spectra from structures according to some embodiments of the present invention. In FIG. 1, illustrating an arrangement of the prior art, the surface of a macroscopic object 1 is coated with a metal coating 3. The metal coating 3, as material made of metal in general, has a high reflectance to visible light in some part of the visible wavelength band, and a large part of the reflected light is specularly reflected. This combination of optical properties of the metal coating 3 provides a “metallic” appearance for the macroscopic object 1. Even thin metal coatings 3 efficiently prevent visible light from penetrating deep into the metal coating 3 as the part of visible incident light which is not reflected is efficiently absorbed into the metal coating 3. For this reason reflectance from the surface of the metal coating 3 is not significantly affected by interference effects caused by light reflected from the interface between the metal coating 3 and the object 1. Hence, a reflectance spectrum which is relatively independent of the viewing angle and depends almost entirely on the material properties of the metal coating 3 may be achieved. Metal coatings 3 are, however, electrically conductive, which is partly the reason for their optical properties discussed above. The appearance of the object 1 is also difficult to tailor with metal coatings 3 as the optical properties of the coating depend predominantly on the material properties of the coating and not e.g. on the thickness of the coating. This may result in a need to use potentially expensive metal coatings to give a specific metallic look to the object 1, especially if the coating is applied over large surface areas on macroscopic objects 1. Examples of expensive metal coatings 3 are gold, and platinum.

For reasons of simplicity, item numbers will be maintained in the following exemplary embodiments in the case of repeating components.

The structure of FIG. 2 according to one embodiment of the present invention comprises a stack of thin-films which are all dielectric and essentially transparent in the visible wavelength band. The surface of the macroscopic object 1 comprises properties in accordance with the present invention. The thin-film stack of FIG. 2 being made of essentially visibly transparent material reflects light in the visible wavelength band specularly with insignificant diffuse reflection. The thin film-stack also reduces the fraction of light impinging on the surface of the macroscopic object 1 which may reflect visible light also diffusely. Therefore the reflectance of specularly reflected visible light in the visible wavelength band from the surface can be increased by fabricating the thin-film stack presented in FIG. 2 on the surface of the macroscopic object 1, as opposed to a situation where, the potentially diffusely reflecting, surface of the macroscopic object 1 is directly exposed to the environment. For this reason the structure of FIG. 2 comprising a thin-film stack on a surface of a macroscopic object 1 can provide a “metallic” appearance to the object 1 with dielectric, visibly transparent, thin-films.

The thin-film stack of FIG. 2 comprises high-index thin-films 5 with a higher refractive index and low-index thin-films 7 with a lower refractive index. The reflectance spectrum of the structure of FIG. 2 comprising the thin-film stack on a surface of a macroscopic object 1 is a combined result of reflection from the surface of the film stack, and interference of light transmitted through the surface of the film stack and reflected from the several boundaries between the high-index 5 and low-index 7 thin-films and from the surface of the macroscopic object 1.

When visible light is incident to the stack of thin-films 5, 7 of FIG. 2, some of the light is reflected from the boundary between air (or any other medium from which light impinges on the stack) and the surface of the structure. This reflection is almost entirely specular as the outermost high-index thin-film 5 is transparent to visible light; the higher is the refractive index of the outermost thin-film, the higher is the reflectance from the surface of the structure. The part of the incident light which is transmitted through the surface of the film stack undergoes several reflections inside the transparent dielectric thin-film stack from the boundaries between the high-index 5 and low-index 7 thin-films and the surface of the object 1. This part of incident light interferes with the light reflected from the surface of the structure, affecting the reflectance spectrum of the reflecting film structure. Majority of the dependence of the reflectance spectrum on the angle of incident light (and therefore also on the viewing angle) in the visible wavelength band is caused by the interference. This dependence can be minimized with an essentially flat reflectance spectrum in and around the visible wavelength band. The essentially flat reflectance spectrum results in a relatively uniform “metallic” look even over complex three dimensional macroscopic objects 1 independently of the viewing angle (i.e. regardless of the interference). In practice, the essentially flat reflectance spectrum can be obtained by suitably choosing the thickness and the refractive index of each thin-film 5, 7 in the stack. Examples of suitable choices of these parameters will be disclosed below.

The structure of FIG. 3 according to one embodiment of the present invention comprises only one single dielectric, visibly transparent, thin-film 9. The surface of the macroscopic object 1 comprises properties in accordance with the present invention. The thin-film 9 of FIG. 3 being made of essentially visibly transparent material reflects light in the visible wavelength band specularly with insignificant diffuse reflection. The thin-film 9 also reduces the fraction of light impinging on the surface of the macroscopic object 1 which may reflect visible light also diffusely. Therefore, the reflectance of specularly reflected visible light in the visible wavelength band from the surface can be increased by fabricating the thin-film 9 presented in FIG. 3 on the surface of the macroscopic object 1, as opposed to a situation where the, potentially diffusely reflecting, surface of the macroscopic object 1 is directly exposed to the environment. Therefore, the structure of FIG. 3 comprising a thin-film on a surface of a macroscopic object can provide a “metallic” appearance to the object with only a single dielectric, visibly transparent, thin-film 9.

The thin-film 9 of FIG. 3 has a higher refractive index than the medium from which light is incident to the surface of the thin-film 9. The reflectance spectrum of the structure of FIG. 3 comprising the thin-film 9 on a surface of a macroscopic object 1 is a combined result of reflection from the surface of the structure (the thin-film 9), and interference of light transmitted through the surface of the structure and reflected from the boundary between the thin-film 9 and the surface of the macroscopic object 1.

When visible light is incident to the thin-film 9 of FIG. 3, some of the light is reflected from the boundary between air (or any other medium from which light impinges on the stack) and the surface of the structure. This reflection is almost entirely specular as the thin-film 9 is transparent to visible light; the higher is the refractive index of the thin-film 9, the higher is the reflectance from the surface of the structure (the thin-film 9). The part of the incident light which is transmitted through the surface of the structure may undergo a specular and/or diffuse reflection from the boundary between the thin-film 9 and the surface of the object 1. This part of incident light interferes with the light reflected from the surface of the structure affecting the reflectance spectrum of the reflecting film structure. Majority of the dependence of the reflectance spectrum on the angle of incident light (and therefore also on the viewing angle) in the visible wavelength band is caused by the interference. This dependence can be minimized with an essentially flat reflectance spectrum in and around the visible wavelength band.

The essentially flat reflectance spectrum results in a relatively uniform “metallic” look even over complex three dimensional macroscopic objects 1 independently of the viewing angle (i.e. regardless of the interference). In practice, the essentially flat reflectance spectrum can be obtained by suitably choosing the thickness and the refractive index of the thin-film 9. Examples of suitable choices of these parameters will be disclosed below.

In FIG. 1, FIG. 2 and FIG. 3 the arrows schematically indicate the direction of incident light.

In one embodiment of the invention the structure comprising a reflecting thin-film on the surface of the object 1 is covered by a visibly transparent polymer coating 11 which may have a reflectance of specularly reflected visible light in the visible wavelength band from the surface higher than that of the structure underneath the polymer coating 11. This embodiment is presented in FIG. 4. A benefit of this embodiment is that the polymer coating 11 protects the dielectric film structure underneath while retaining or even increasing the reflectance of specularly reflected visible light in the visible wavelength band from the surface achieved by the uncoated dielectric film structure.

In the case where the reflection from the surface of the object 1 is essentially zero, e.g. in the case of a black surface, interference does not occur in the embodiment of FIG. 3, and the reflectance of the structure depends on the properties of the thin-film 9 material. However, surfaces often reflect part of the incident light specularly and part of the incident light diffusely, in the visible wavelength band. When such a surface is coated with thin-films 5, 7, 9 having a higher ratio of specularly reflected light to diffusely reflected light than the coated surface of the object 1, the ratio of specularly reflected light to diffusely reflected light is increased. This is the case even if the thin-films 5, 7, 9 were transparent to visible light.

A benefit of using the dielectric visibly transparent thin-films 5, 7, 9 is that these thin-films 5, 7, 9 do not markedly reflect light diffusely, but majority of the reflected light from the surface of these thin-films 5, 7, 9 is specularly reflected as long as the surface roughness of the thin-films 5, 7, 9 in the order of the wavelength of visible light is small and the film structure does not contain scattering crystals.

The reflection spectrum of the structures in the embodiments of the invention discussed above depends on an optical parameter, namely the refractive index, and the thickness of the at least one thin-film 5, 7, 9 employed in the structure. Therefore, in order to obtain uniform reflecting properties, and uniform appearance, over a surface of the macroscopic object 1, these film properties should be highly uniform over the surface.

Deposition processes based on alternately repeating, essentially self-limiting, surface reactions of two or more different precursors, one precursor at a time, can be employed to deposit the dielectric thin-films 5, 7, 9 highly uniformly, with high optical homogeneity and high thickness uniformity, even over large surface areas. Such processes include e.g. atomic layer deposition (ALD). Especially when the surface of the object 1 is three dimensional and/or complex in shape, these processes can be used to deposit the thin-films 5, 7, 9 on the surface of the macroscopic object 1 such that the optical properties of the thin-films 5, 7, 9 remain sufficiently uniform over large areas to obtain a homogeneous appearance for the object 1. Additionally, in the embodiments of the invention disclosed above, the surface roughness of the thin-films 5, 7, 9, in the order of the wave-length of visible light, can be minimized in order to minimize the scattering of light as a result of the surface roughness. For this purpose thin-film deposition methods capable of depositing visibly transparent dielectric thin-films with minimal surface roughness can be employed. For this purpose also, atomic layer deposition (ALD) is a suitable deposition method.

In ALD the deposit is grown by alternately repeating, essentially self-limiting, surface reactions between a precursor and a surface to be coated. Therefore the growth of the deposit in an ALD process is commonly not as sensitive as in other coating methods to e.g. the flow dynamics inside a reaction chamber. The flow dynamics may be a source for non-uniformity, especially in coating methods relying on gas-phase reactions such as chemical vapor deposition (CVD), or in physical vapour deposition (PVD) which relies on a directional flux of evaporated or sputtered material. Physical vapour deposition (PVD) relies on a directional flux of evaporated or sputtered material and requires line of sight between the source and coated object. Therefore, these vapor-phase processes may not achieve a sufficient uniformity on large or three dimensional objects 1, to give the object 1 a uniform appearance.

In an ALD process two or more different reactants (precursors) are introduced to the reaction chamber in a sequential, alternating, manner and the reactants adsorb on surfaces, e.g. on an object 1, inside the reaction chamber. The sequential, alternating, introduction of reactants is commonly called pulsing or dosing (of reactants). In between each reactant pulse there is commonly a purging period during which a flow of inert gas, often called the carrier gas, purges the reaction chamber from e.g. surplus precursor and by-products resulting from the adsorption reactions of the previous precursor pulse. A film can be grown by an ALD process by repeating, possibly several times, a pulsing sequence comprising the aforementioned reactant pulses and purging periods. The number of how many times this sequence called the “ALD cycle” is repeated depends on the targeted film, or coating, thickness.

The method for fabricating a structure comprising at least one reflecting thin-film on a surface of a macroscopic object 1 in some embodiments of the present invention will be described in more detail below, in the context of examples of structures comprising at least one reflecting thin-film on a surface of a macroscopic object 1 according to some embodiments of the present invention.

### EXAMPLES

The data of FIG. 5 illustrates the reflectance spectra for four different structures. In these cases the surface of the macroscopic object 1, on which the at least one reflecting thin-film is fabricated, has reflective properties, which should be taken into consideration in order to obtain optimum results. For illustrating the inventive idea in the following examples, the at least one reflecting thin-film was fabricated on a glass substrate. The reflectance spectra were measured from the glass substrate and obtained for light which was incident perpendicularly to the surface of the structure (normal incidence geometry). The refractive index of the substrate was 1.52 and the substrate can be assumed optically infinitely thick. The glass substrate was a 0.3 mm thick D263T glass. The detailed structure of the three thin-film stacks of total thickness of about 260 nm, 639 nm and 940 nm is described below.

substrate

Total thickness about 260 nm

| | |
|---|---|
| TIO | 16.1 nm |
| ALO | 33.6 nm |
| TIO | 63.3 nm |
| ALO | 90.1 nm |
| TIO | 58.5 nm |
| air | |

Total thickness about 630 nm

| | |
|---|---|
| TIO | 11.9 nm |
| ALO | 44.1 nm |
| TIO | 55.0 nm |
| ALO | 31.4 nm |
| TIO | 23.7 nm |
| ALO | 79.1 nm |
| TIO | 51.3 nm |
| ALO | 19.1 nm |
| TIO | 37.5 nm |
| ALO | 80.7 nm |
| TIO | 51.1 nm |
| ALO | 82.2 nm |
| TIO | 62.4 nm |
| ALO | 1.9 nm |
| air | |

Total thickness about 940 nm

| | |
|---|---|
| TIO | 40.5 nm |
| ALO | 66.0 nm |
| TIO | 43.3 nm |
| ALO | 72.3 nm |
| TIO | 47.1 nm |
| ALO | 77.4 nm |
| TIO | 54.0 nm |
| ALO | 107.1 nm |
| TIO | 64.9 nm |
| ALO | 83.7 nm |
| TIO | 74.0 nm |
| ALO | 101.4 nm |
| TIO | 58.6 nm |
| ALO | 43.0 nm |
| TIO | 4.7 nm |
| air | |

These three film structures correspond to the embodiment presented in FIG. 2. TIO refers to a high-index thin-film 5 with a refractive index of 2.40 and ALO refers to a low-index thin-film 7 with a refractive index of 1.62. The uppermost line of each thin-film stack refers to the thin-film 5, 7 which is directly on the substrate (on the surface of the object 1) and the lowermost line refers to the thin-film 5, 7 which is on the surface of the whole thin-film stack, exposed to the environment (air in these examples). The refractive index of the thin-film 9 in the single layer structure, corresponding to the embodiment of FIG. 3, was 2.40 and the thickness was 55 nm. All thin-films 5, 7, 9 were dielectric and essentially transparent in the visible wavelength range.

As can be seen from the data of FIG. 5, even a single layer with a suitably chosen thickness and material with a suitable refractive index can be used on an object 1 to provide an essentially flat reflectance spectrum in and around the visible wavelength range. Therefore the structure comprising a single, visibly transparent, dielectric layer on an object, can surprisingly increase the reflectance of specularly reflected visible light in the visible wave-length band from the surface giving the surface of the object 1 a more “metallic” appearance essentially independent of the angle of incidence (and therefore independent of the viewing angle). The single-film structure corresponding to FIG. 3 is a very reliable and cost-effective structure for increasing the reflectance of specularly reflected visible light in the visible wavelength band from the surface. This kind of single-film structure does not require much material and is less susceptible to cracking by stresses in the structure caused by e.g. thermal expansion or lattice mismatch of the thin-film material to the substrate (i.e. to the surface of the object 1). Incompatibilities between a thin-film coating and a substrate can potentially occur especially between an inorganic film and a substrate containing organic materials like plastics or elastomers.

Suitably designed thin-film stacks, having a total thickness of much larger than the single thin-film 9, can also provide essentially uniform reflectance spectra in and around the visible wavelength band. Examples of this are the thin-film stacks having a total thickness of about 260 nm and 630 nm presented above. The thin-film stack having a total thickness of about 940 nm has a high average reflectance thereby having the potential of drastically increasing the reflectance of specularly reflected visible light in the visible wavelength band from the surface. This particular structure nevertheless has a non-uniform reflectance spectrum in the visible wavelength band, which may give rise to color variations over large or non-planar surfaces.

FIG. 6 and FIG. 7 present reflectance spectra similar to the ones presented in FIG. 5 but only for various single-film structures corresponding to FIG. 3. The reflectance spectra of FIG. 6 are for structures in which the thin-film 9 has a refractive index of 2.40 while thickness of the thin-film 9 varies as presented in the figure. FIG. 6 clearly presents that there exists an optimum thickness range for a given value of the refractive index for the thin-film 9 in the single-film structure corresponding to FIG. 3. It can be observed from FIG. 6 that decreasing the thick-ness of the thin-film 9 from 120 nm down to 55 nm and keeping the refractive index of the thin-film 9 constant, the reflectance spectrum becomes essentially flat in the visible wavelength range. If the thickness is still decreased from 55 nm the reflectance spectrum looses its flatness in the visible wavelength range. There exists therefore an optimum thickness range for obtaining an essentially flat reflectance spectrum in the visible wavelength range. The reflectance spectra of FIG. 7 are for different, essentially optimized, single-film thin-film structures in which both the refractive index and the thickness of the thin-film 9 varies. The thickness of the substrate can be assumed optically infinite and the refractive index of the substrate was 1.52. Coating is performed on a single side of the glass substrate and the glass substrate is a 0.3 mm thick D263T glass.

From FIG. 6 and FIG. 7 it can be inferred that essentially flat reflectance spectra in the visible wavelength range can be produced with the simple structure of FIG. 3, when the refractive index and the thickness of the thin-film 9 are suitably chosen. In general, the higher the refractive index of the thin-film 9 is the thinner the thin-film 9 can be, and the higher is the average reflectance produced by the structure.

All thin-films were dielectric and essentially transparent in the visible wavelength range in the examples above.

The thin-films 5, 7, 9 in the above examples can be synthesized and deposited on the surface of an object 1 by e.g. an ALD process in a reactor suitable for ALD. For example the thin-films referred to as ALO above can be of e.g. amorphous aluminum oxide, Al₂O₃, deposited on a glass substrate or on any other object suitable for the process. Al₂O₃ thin-films can be deposited in an ALD process by alternately exposing the substrate to e.g. trimethylaluminum and de-ionized water at a temperature in the range of e.g. 100° C.-300° C. The details of the Al₂O₃ process depend on e.g. the deposition tool and will be obvious for a skilled person in light of this disclosure. Amorphous Al₂O₃ thin-films deposited by ALD can possess a smooth surface morphology and a refractive index commonly around 1.5-1.7.

The thin-films referred to as TIO above and the thin-films in the exemplary structures comprising only a single thin-film 9 can be of e.g. amorphous titanium oxide, TiO₂, deposited on a glass substrate or on any other object 1 suitable for the process. TiO₂ thin-films can be deposited in an ALD process by alternately exposing the substrate to e.g. titanium-tetrachloride and de-ionized water. Suitable temperatures for depositing TiO₂ by ALD range from e.g. room temperature (around 20° C.) to over 600° C. Amorphous TiO₂ thin-films can be deposited by ALD at the lower temperatures e.g. in the range of 20-150° C. At this temperature range the TiO₂ thin-films can be deposited on e.g. some polymer substrates. The details of the TiO₂ process depend on e.g. the deposition tool and will be obvious for a skilled person in light of this disclosure. Amorphous TiO₂ thin-films deposited by ALD can possess a smooth surface morphology and a refractive index commonly around 2.0-2.5. Also due to its chemical stability, TiO₂ is a very suitable material to be used as a thin-film material in the embodiments above. Especially in chemically aggressive environments TiO₂ films can protect underlying film structures or objects 1. Indeed another benefit of employing only dielectric thin-films in the structure is that dielectric materials often have good adhesion on a wide spectrum of substrate materials, and many dielectric materials also exhibit good corrosion resistance properties.

Deposition of the thin-films 5, 7, 9 in the examples above was carried out using the commercially available P400A ALD reactor from Beneq Oy, Vantaa, Finland. The deposition temperature was about 105° C. for both the TiO₂ and the Al₂O₃ thin-films. A total flow of carrier gas of 2 SLM was used through the P400A coating tool during the deposition process, and the pressure in the reaction chamber was about 1 hPa. The ALD deposition cycles were as follows:

For TiO₂;

0.4 s H₂O+2 s Purge+0.3 s TiCl₄+2 s Purge

For Al₂O₃;

0.4 s H₂O+5 s Purge+0.6 s TMA (trimethylaluminum)+5 s Purge

The ALD cycles and the precursors employed are exemplary embodiments which are disclosed to enable a person skilled in the art to use the invention. Modifications e.g. to the precursors, to the film materials employed, and to the various process parameters will be obvious to the skilled person in light of the disclosure above.

As is clear for a person skilled in the art, the invention is not limited to the examples described above but the embodiments can freely vary within the scope of the claims.

1. A structure comprising at least one reflecting thin-film on a surface of a macroscopic object, wherein the surface of the macroscopic object, without the at least one thin-film, reflects less than 50% of incident light in the visible wavelength band and is opaque, and reflection of visible light from the surface of the macroscopic object, with the at least one thin-film on the surface of the macroscopic object, is essentially spectrally uniform and flat over available viewing angles, and the at least one thin-film is dielectric and essentially transparent to visible light, and the at least one thin-film is fabricated by exposing the surface of the macroscopic object to alternately repeating, essentially self-limiting, surface reactions of two or more precursors, for increasing the reflectance of specularly reflected visible light in the visible wavelength band from the surface.

2. The structure of claim 1, wherein the macroscopic object is arranged to perform RF-functions or electrical insulation functions.

3. The structure of claim 1, wherein the surface of the macroscopic object, without the at least one thin-film, reflects less than 40%, preferably less than 20%, most preferably less than 10%, of incident light in the visible wavelength band.

4. The structure of claim 1, wherein the diffuse reflection of visible light from the surface of the macroscopic object, without the at least one thin-film, is essentially spectrally uniform and flat.

5. The structure of claim 1, wherein the surface of the macroscopic object, without the at least one thin-film, is essentially black.

6. The structure of claim 1, wherein the surface of the macroscopic object is selected from a group consisting of polymer and glass.

7. The structure of claim 1, wherein the at least one dielectric thin-film is fabricated by an atomic layer deposition type process.

8. The structure of claim 1, wherein the structure comprises only one thin-film, the refractive index of the thin-film being above 1.5, preferably above 1.8 and most preferably above 2.1, in the visible wavelength range.

9. The structure of claim 1, wherein the thickness of the thin-film is in the range of 20 nm to 100 nm.

10. The structure of claim 1, wherein the material of the thin-film is selected from the group consisting of titanium oxide and aluminum oxide.

11. A method for fabricating a structure comprising at least one reflecting thin-film on a surface of a macroscopic object, wherein the method comprises the step of,
depositing at least one thin-film on the surface by exposing the surface to alternately repeating, essentially self-limiting, surface reactions of two or more precursors, the surface of the macroscopic object, without the at least one thin-film, reflecting less than 50% of incident light in the visible wavelength band and being opaque, and reflection of visible light from the surface of the macroscopic object, with the at least one thin-film on the surface of the macroscopic object, being essentially spectrally uniform and flat over available viewing angles, and the at least one thin-film being dielectric and essentially transparent to visible light, for increasing the reflectance of specularly reflected visible light in the visible wavelength band from the surface.

12. The method of claim 11, wherein the macroscopic object is arranged to perform RF-functions or electrical insulation functions.

13. The method of claim 11, wherein the surface of the macroscopic object, without the at least one thin-film, reflects less than 40%, preferably less than 20%, most preferably less than 10%, of incident light in the visible wavelength band.

14. The method of claim 11, wherein the diffuse reflection of visible light from the surface of the macroscopic object, without the at least one thin-film, is essentially spectrally uniform and flat.

15. The method of claim 11, wherein the surface of the macroscopic object, without the at least one thin-film, is essentially black.

16. The method of claim 11, wherein the surface of the macroscopic object is selected from a group consisting of polymer and glass.

17. The method of claim 11, wherein the step of depositing at least one dielectric thin-film comprises, depositing the at least one thin-film by an atomic layer deposition type process.

18. The method of claim 11, wherein the structure comprises only one thin-film, the refractive index of the thin-film being above 1.5, preferably above 1.8 and most preferably above 2.2, in the visible wavelength range.

19. The method of claim 11, wherein the thickness of the thin-film is in the range of 20 nm to 100 nm.

20. The method of claim 11, wherein the material of the thin-film is selected from the group consisting of titanium oxide and aluminum oxide.

21. Use of the structure of claim 1 as a means to increase the reflectance of specularly reflected visible light in the visible wavelength band from the surface of a macroscopic object.

22. Use of the method for fabricating a structure of claim 11 as a method to increase the reflectance of specularly reflected visible light in the visible wavelength band from the surface of a macroscopic object.
